(19) United States
(12) Patent Application Publication
(10) Pub. No.: US 2026/0050968 A1
(43) Pub. Date: Feb. 19, 2026

(54) System And Method for a Mobile Application for Restaurant Hosting and Operation

(71) Applicant: Laura Christine Leonetti, Mayfield Heights, OH (US)

(72) Inventor: Laura Christine Leonetti, Mayfield Heights, OH (US)

(21) Appl. No.: 19/282,371

(22) Filed: Jul. 28, 2025

Related U.S. Application Data
(60) Provisional application No. 63/678,098, filed on Aug. 1, 2024.

(51) Int. Cl. G06Q 30/0601; G06Q 10/02; G06Q 20/20; G06Q 20/32; G06Q 50/12

(52) U.S. Cl. CPC G06Q 30/0643; G06Q 10/02; G06Q 20/20; G06Q 20/322; G06Q 50/12

(57) ABSTRACT

A system and method for a mobile application configured to serve as a virtual host for restaurants and dining establishments, facilitating communication between diners and service staff including bussers, servers, bartenders, and kitchen personnel. The application enables customers to input preferences and check in on-site or remotely, assigns seating, and dispatches real-time instructions for service tasks. Visual and auditory signaling components, such as lights and displays, alert staff to pending or overdue duties, escalating missed actions to management if necessary. The application tracks each service interaction and integrates with point-of-sale (POS) systems to utilize customer profiles, manage orders, process payments, and collect feedback. It is operable via smartphones, kiosks, tablets, or terminals, and supports modular, scalable deployment across diverse dining environments. The system enhances service efficiency, reduces wait times, and ensures consistent guest experiences through automated oversight and dynamic staff coordination.

### TECHNICAL FIELD OF THE INVENTION

The present invention is directed to an apparatus and method for a mobile application that facilitates, coordinates and streamlines restaurant and café hosting and general operation for improved customer experience and satisfaction.

### BACKGROUND OF THE INVENTION

This invention relates to a user-friendly electronic application designed to function as a virtual host or maître d′ in restaurants, coordinating front- and back-of-house personnel to enhance efficiency, reduce customer wait times, and ensure seamless service. The application interfaces with a POS system and customer mobile devices to manage check-in, seating preferences, food ordering, payment processing, and even personalized data such as allergies or past orders, anniversaries, birthdays and other personal information. Through real-time communication and alerts using visual indicators like colored lights and coded signals, it ensures timely task execution by bussers, servers, and other staff, escalating missed tasks to managers if necessary. The system is adaptable to various dining environments and deployable over networked servers, enabling both on-premise and remote monitoring and control for optimized customer experiences.

Prior systems have enabled wireless communication between patrons and service staff using handheld devices to transmit orders during dining. Other solutions have implemented wireless paging and customer-location tracking via pager-caddies attached to venue fixtures. Dining tables integrated with computing terminals have allowed users to simultaneously eat and access the internet. Mobile applications have facilitated on-premise ordering via smartphones, with staff fulfilling requests while leveraging real-time marketing and social networking. Interfaces have also emerged that let customers choose levels of waiter interaction, dynamically adjusting the user experience accordingly. Paging systems using table-mounted transmitters and wearable server receivers have enabled order queuing and staff performance tracking via location-aware timers. Location-sensitive queue systems have used mobile devices and wireless signals to manage pickup timing and order readiness in drive-through contexts. Gesture-based ordering systems have employed video analytics to recognize specific patron gestures and translate them into service requests. Robotic waiters have been designed with rotatable displays and directional audio sensors to align with speaking patrons. Finally, drive-through systems have coordinated multi-vendor orders by splitting them based on preparation times, routing them for simultaneous delivery at a shared pickup station, and using vertical transport mechanisms to consolidate fulfillment.

The present invention is directed to a user-friendly electronic application configured to operate as a virtual host or maître d' in dining environments such as restaurants, cafés, or other food service venues. The application enables direct interaction with customers and coordinates staff functions including bussers, servers, kitchen personnel, and management. The system facilitates optimized guest flow, efficient table service, and enhanced customer experience by tracking real-time service activity, issuing alerts, and managing pending tasks through visual and/or auditory signaling mechanisms. The application may operate as a standalone platform or integrate with point-of-sale (POS) systems to achieve seamless interaction with existing restaurant infrastructure.

According to one aspect, the application allows a diner to register upon arrival-either on-site or remotely- and input dining preferences, such as seating location or special considerations. Once registered, the application assigns the diner a table and sends task instructions to designated staff. For instance, bussers may be alerted to deliver introductory items, and servers may be notified when to engage with the customer for initial orders. Each service event is logged within the application, and timing thresholds may be employed to ensure timely task completion. In the event of a delay, escalation alerts may be automatically sent to other staff or management, ensuring the continuity of service and avoiding service lapses.

In another embodiment, the application is implemented as part of a POS system wherein customer data-including identity, preferences, loyalty profile, and historical order information—is retrieved and utilized to personalize service. The system is further capable of processing payment methods, delivering bills, and capturing feedback. It employs a modular interface comprising server, busser, and bartender inputs to track customer needs across all phases of dining. Dynamic communication is enabled through color-coded signals, text prompts, and visual display units, facilitating rapid task identification and response by staff members. The architecture supports centralized or distributed control via a mainframe or multiple zone-specific hubs depending on the scale of the venue.

The system is operable via a networked architecture and accessible through various devices, such as kiosks, tablets, smartphones, and restaurant terminals. The application may be hosted locally or remotely and allows pre-registration or reservation through downloadable apps. It includes a processor-based subsystem configured to receive user input, interpret service logic, and dispatch task instructions to appropriate personnel. The invention is applicable across a range of service environments including casual dining, fine dining, quick service, food trucks, stadiums, and healthcare facilities. The mobile application thus replaces or supplements traditional host roles while integrating human oversight with automated service coordination to deliver a streamlined yet personable dining experience.

### SUMMARY OF THE INVENTION

The present invention is directed to a user-friendly electronic application configured to operate as a virtual host or maître d' in dining environments such as restaurants, cafés, or other food service venues. The application enables direct interaction with customers and coordinates staff functions including bussers, servers, kitchen personnel, and management. The system facilitates optimized guest flow, efficient table service, and enhanced customer experience by tracking real-time service activity, issuing alerts, and managing pending tasks through visual and/or auditory signaling mechanisms. The application may operate as a standalone platform or integrate with point-of-sale (POS) systems to achieve seamless interaction with existing restaurant infrastructure.

According to one aspect, the application allows a diner to register upon arrival-either on-site or remotely- and input dining preferences, such as seating location or special considerations. Once registered, the application assigns the diner a table and sends task instructions to designated staff. For instance, bussers may be alerted to deliver introductory items, and servers may be notified when to engage with the customer for initial orders. Each service event is logged within the application, and timing thresholds may be employed to ensure timely task completion. In the event of a delay, escalation alerts may be automatically sent to other staff or management, ensuring the continuity of service and avoiding service lapses.

In another embodiment, the application is implemented as part of a POS system wherein customer data-including identity, preferences, loyalty profile, and historical order information—is retrieved and utilized to personalize service. The system is further capable of processing payment methods, delivering bills, and capturing feedback. It employs a modular interface comprising server, busser, and bartender inputs to track customer needs across all phases of dining. Dynamic communication is enabled through color-coded signals, text prompts, and visual display units, facilitating rapid task identification and response by staff members. The architecture supports centralized or distributed control via a mainframe or multiple zone-specific hubs depending on the scale of the venue.

The system is operable via a networked architecture and accessible through various devices, such as kiosks, tablets, smartphones, and restaurant terminals. The application may be hosted locally or remotely and allows pre-registration or reservation through downloadable apps. It includes a processor-based subsystem configured to receive user input, interpret service logic, and dispatch task instructions to appropriate personnel. The invention is applicable across a range of service environments including casual dining, fine dining, quick service, food trucks, stadiums, and healthcare facilities. The mobile application thus replaces or supplements traditional host roles while integrating human oversight with automated service coordination to deliver a streamlined yet personable dining experience.

### BRIEF DESCRIPTION OF THE DRAWING

FIG. 1 is a schematic diagram illustrating an exemplary flow of operations within a restaurant environment utilizing an electronic application for customer service orchestration. The diagram depicts the capture and input of customer identity and associated information into an electronic interface, followed by the determination of a specific table assignment and corresponding location data. Upon customer arrival, the system initiates predefined service protocols, including automated or staff-prompted delivery of preliminary items such as water and bread. Subsequent service stages are coordinated through the application and include the ordering and delivery of appetizers, beverages, and entrees. The FIGURE further delineates the interaction between front-of-house personnel, such as bussers and servers, and back-of-house entities including the kitchen and bar, thereby illustrating the application's facilitation of synchronized service delivery and task delegation across operational nodes.

### DETAILED DESCRIPTION OF THE INVENTION

Electronic applications are facilitating operations in many retail aspects, including airports, banks, store checkouts, and even restaurants. For example, point of sale (“POS”) technology employs hardware and software that restaurants may use to process certain transactions, manage orders, and run their business. POS systems are more often a critical component of a restaurant's operations, allowing them to manage the entire operation, from the front of house (FOH) to the back of house (BOH). POS systems are generally limited to customer based applications to allow customers to communicate directly to the restaurant or cafe to streamline orders, a process that generally eliminates a middleman and uses computer technology to ensure accuracy and speed up the customer transaction. Such applications are useful in streamlining certain aspects of commerce and have even reduced the need for live persons to be involved. In the case of self checkout, now common at most grocery stores, customers use a kiosk to check their items, self bag them and pay without the need for a single cashier to assist. The food and restaurant industries are also implying electronic applications, including mobile applications order takeout and delivery of items. Some restaurants may even employee kiosks that allow customers to place orders electronically for dining in experiences. Each of these applications has had beneficial effects for both the customer and the merchant. However, applications generally lack human intervention and reasoning that is necessary to deal with ensuring an enjoyable experience and are generally designed to increase efficiency in the commercial process. In restaurants, these systems are generally not used in situations in which human interaction and oversight is necessary to ensure enjoyment, such as fine restaurants where the customer expects to enjoy dining in a relaxed and entertaining environment. Further, certain experiences demand as much human interaction and as little electronic application as possible. Nevertheless, there exists a need for assisting hosts, hostesses, maître d′ and headwaiters to smoothly facilitate and operate restaurants and cafés during times of high activity to ensure that tables or diners are not accidently overlooked due to high demand and volume.

The invention relates, on one hand, to an apparatus that is a user-friendly electronic application, that allows restaurants to interact with customer by providing customer with application that acts as a host, hostess or maître d′. The application may operate by coordinating servers, waiters, bussers, and other assistants to maximize efficiency, ensure that customers are served without extended wait periods, ensure customers are not overlooked, and decrease confusion or difficulty that may be associated with restaurant personnel.

According to one aspect of the invention, the invention is an independent application in which the user, for example a diner, registers or logs in to the application in a user-friendly manner that acts as the diner interacting with a host or hostess. The user/diner inputs ding preferences which preferences are inputted in the system. The application provides seating information for the diner and notifies a designated busser or bussers through a preferred signaling device that the diner's table or location is ready for introductory items, such as bread and water. The busser communicates with the application upon completion of the task. In one embodiment, the application notifies a designated server or serves through a preferred signaling device, either prior to completion of a busser's task or after completion of a busser's task that the server or servers are ready to attend to the diner. The signaling mechanisms, discussed herein, are any applicable signaling method, such as a small hand held application or larger display monitor that contains red and green lights or other lighting system that alerts a busser or server that a task remains to be completed or has been completed. Ideally, a restaurant has a single main frame display or base that controls the entire application. It would be appreciated by those skilled in the restaurant business that one main frame is ideal to ensure uniformity and a single source of instruction, however, it will be equally appreciated that venues with numerous rooms, sections or locations, such as resorts, might require more than one main base for monitoring and control.

In another aspect of the invention, the invention relates to user-friendly electronic application designed to function as a virtual host or maître d′ in restaurants, coordinating front- and back-of-house personnel to enhance efficiency, reduce customer wait times, and ensure seamless service. The application interfaces with a POS system and customer mobile devices to manage check-in, seating preferences, food ordering, payment processing, and even personalized data such as allergies or past orders, anniversaries, birthdays and other personal information.

In another aspect of the invention, the application is used in conjunction with a POS system. The POS system is a method of computer implementation for interacting with a customer or restaurant under the control of an integrated customer interface module stored in a computer memory and configured to communicate with a wireless mobile device of a customer. A POS system generally involves interaction between a customer and a restaurant chain comprising a means for performing, under control of an integrated customer interface module stored in a computer memory and configured to communicate with a wireless mobile device of a customer and a POS system associated with the restaurant, the actions of: receiving a request from the customer to check in; automatically generating an instruction in the POS system; receiving information regarding the customer from a remote database; and sending at least a portion of the information regarding the customer to the POS system. In some embodiments, the computer interface system further comprises means for performing the action of automatically detecting a current location of the customer. In some embodiments, the computer interface system further comprises means for performing the action of receiving a bill and automatically calculating one or more payment options, the payment options comprising one or more of debit card, credit card, cash, gift card, and loyalty program points. In some embodiments, the customer information comprises at least one of the customer's name, the customer's profile maintained by a merchant or a group of related merchants, picture, loyalty program ID, past dining history, food preferences, allergies, and a favorite entree.

In some embodiments of the POS, the computer interface system further comprises means for performing the action of notifying a host at the specific restaurant where the customer has checked in and providing at least a portion of the customer information to the specific restaurant. In some embodiments, the computer interface system further comprises means for performing the action of receiving food order details from the customer and presenting a total amount due to the customer. In some embodiments, the computer interface system further comprises means for performing the action of receiving payment instructions from the customer. In some embodiments, the payment instructions comprise at least one of payment card type, payment card information, tip, and loyalty program information. In some embodiments, the computer interface system further comprises means for performing the action of receiving billing information from a card reader and processing a payment from the customer. In other embodiments, the computer interface system further comprises means for performing the action of receiving feedback from the customer regarding a dining experience. In the current state of the art, POS systems lack the feature of the present invention, which substitutes the host for the application at a restaurant or bar at a dining facility.

In another embodiment, the application may be used independently or in conjunction with a POS system. For example, POS systems are largely used at restaurant chains as a means of facilitating the efficiency of fast food, in conjunction with ordering remotely or on site, or in conjunction with food delivery applications and methods.

According to one aspect of the invention, the application may be monitored and controlled by a local or remote user. The application contains data that defines the restaurant, or section of a restaurant or seating area within the restaurant, to which it may apply. The application may contain server information, for example, including the number of servers that may operate during a particular period of time. As an example, if eight waiters or servers may be operating, the eight servers may log in and identify themselves with the application. Bussers or other table assistants who cover all or part of a restaurant or seating area may likewise identify themselves in the application. If other persons, such as managers or other personnel may be overseeing customers, those person may also identifying themselves in the application. In order to operate in a fully functional manner, the application may contain all of the individuals with whom it may alert throughout the course of a period, for example, and evening.

A customer, for example, may enter an establishment and may be greeted by a user-friendly setup that allows a customer to enter information quickly and easily into the application, such as a last name and/or first name, and other identifying information, such as a phone number. Alternatively, a customer may have a unique identifier, such as an alphanumeric password, that allows the customer to quickly input the information into the application. The application may also prompt the customer to add information such as the number of diners in the customer's group.

Once a customer provides information, including the number of diners, the type of preferred seating, such as window seating, outdoor seating, seating in a certain ambiance that the restaurant may offer, or seating near a warmer or cooler area, the application may quickly determine a location for the customer(s) and provide them with user-friendly instructions for locating their sit. Alternatively, the application may alert a server or other person to assist the customer(s) toward their designated dinging location.

Once customers are seated at the designated dinging location, the application may alert the designated busser or other personnel for the initial interaction with the customers, usually which services compromise providing introductory drink, such as water and introductory food, such as bread and butter, for the customer(s). When the busser completes initial service, the busser may identify with the application, through a predetermined mechanism, that the initial service has been completed. If the busser fails to promptly, for example, within four minutes, complete the introductory service, the application may immediately notify the busser through a notification that the service needs immediate attention. If the busser fails to complete the service a second time, the server, and any other designated person associated with the application may be placed on notice so that the situation may be immediately addressed. The application may contain a further backup system that notifies a manager or other personnel if an initial or secondary failure of busser service occurs within a specified period of time.

After the application receives a signal that the initial service is complete, it may notify the server. At a designated time, for example, within three minutes of completion of the introductory service, the server may be alerted by the application that the customers' initial orders should be taken. Typically, the servers may start by requesting any drink orders, including cocktails, alcoholic drinks or non-alcoholic drinks, so that the customers may commence enjoyment of the evening while they consider food options, such as appetizers, main course, dinner drinks, alternate course and after dinner options. The servers may alternatively take orders associated with appetizers or any special considerations, including consideration of special occasions such as birthdays, anniversaries, physical considerations such as allergies, child or elderly needs and the like. Once the server takes the initial drink and/or appetizer orders or other special considerations from the customer, the server identifies completion with the application. The application may contain, and ideally does contain, general considerations for which the server may identify that are pre-programed as well as the opportunity to enter specific considerations in the application that may be manually inputted. The server may then relay order for drinks to the bar, food orders to the kitchen and other considerations as may be necessary and identify them as complete with the application. If one or more initial considerations is not marked as complete, the application may keep these items open, and alert the server in a designated time, such as five minutes, that initial considerations remain incomplete and prompt the server to compete them.

When the server transfers order to the bar or the kitchen, the application may place these orders with the respective location until such time that the orders are ready, at which time the bartender or kitchen associate may identify the order as fulfilled and transfer the obligation for delivery to the server, or in other cases, to a specially designated person or team of individuals who may be responsible for service of the particular orders to the customer. For example, in some restaurants, appetizers or entrees may be served by kitchen staff as opposed to the servers. In this case, the application may be programmed to alert these personnel regarding the time to serve such orders to the customer.

After initial orders, such as drink or appetizers are delivered, the application may prompt the server, within a specified period of time, to return to the customer and obtain any further order, such as a main course. As described above, the server may again take orders, identify them in the application and deliver them to the bar or kitchen as required. The application may continue to track food and beverage, as well as other requested accommodations throughout the course of the customers' dining experience. This would include the need for an additional order from one diner that is not part of the main order, or an order that is returned or replaced. Often times these anomalies are so irregular that servers forget about them, and a diner is left with an incomplete order for a lengthy period of time. The application may track these changes and set alerts for the server to ensure they are completed.

The application may be used to keep track of orders, including food and drink, and special considerations. The application works in concert with the managers, servers, bussers, bartenders, cooks, kitchens, and other service providers. It may use a series of alerts and messages, such as color light coding, that can easily be noted by the service provider and a manager if a task is missed by a busser, server or other personnel. Letters, numbers, charts, lights, such as green, blue, red, yellow, gold, orange, pink, purple and white lights, and in multiple combinations may be used to send a signal to a service provider. Letters and numbers may be used as well, all of which can be combined to identify location, customer, item and urgency. For example, the application may send a signal using a combination of lights, letters, and other types of maps to signal a missing cocktail or appetizer at a certain location, which may allow the server to quickly remedy the problem without the need to review notes and go around to various tables to determine if an order has been unfulfilled.

According to one aspect of the invention, the disclosed systems and/or methods may be utilized with respect to casual dining, fine dining, fast food dining, food courts, food trucks, movie theaters, sports stadiums, bars, buffets, coffee shops, hospitals, nursing homes, pick-up/carry out ordering locations, sports arenas, other food and/or beverage providers, combinations thereof, or the like. For example, without limitation, different types of food providers may need different features to service their customers. Each restaurant may be associated with a service level, such as but not limited to, minimum, mid-level, or full service.

The application used may be in electronic communication with computer servers by way of one or more networks. The networks may comprise one or more internets, intranets, cellular networks, some combination thereof or the like. The networks may include the world wide web, for example without limitation. Such connections may be made by way of wired connections, wireless connections, some combination thereof, or the like. The applications may be mobile and available to the public as downloadable applications or apps, such that a customer may pre-register or obtain reservations and when arriving at the restaurant, merely identify a code. A registration may allow a customer to pre-identify and reserve a seat, place or table in a restaurant, and may allow the customer to pre-order some or all of the desired food, drink or other considerations.

The server used in the application may be configured to host an application installed on and/or accessed by the customer devices. For example, some or all of the application may be installed on each of the customer devices. In other exemplary embodiments, some or all of the application may be hosted on the servers and accessible on the customer devices by way of the networks. One or more restaurant applications may be in electronic communication with the servers. The restaurant applications or devices may include, for example without limitation, computers, laptops, smartphones, tablets, electronic displays, some combination thereof, or the like. Restaurant applications or devices for each of a number of restaurants, or a single restaurant, may be in electronic communication with the servers. Some or all of the application may be installed on each of the restaurant devices. In other exemplary embodiments, some or all of the application may be hosted on the servers and accessible on the restaurant devices by way of the networks which allow for accessibility by multiple users or managers to ensure that tasks assigned to bussers, servers, bartenders and other personnel are being completed timely or through some other required specification.

In another embodiment, the system comprises at least one processor operatively connected to a memory, a translation component, executed by the at least one processor, configured to receive execution information (e.g., user input from the customer) from at least one customer access point subsystem (e.g., kiosk, access point, mobile device with app., etc.) wherein the execution information is communicated in a first format associated with a first system that communicates instructions to a second system that receives information and sets forth instructions to various personnel. According to another embodiment, the calculation subsystem includes a POS subsystem, and method further comprises capturing and communicating, by the POS subsystem.

In another embodiment, the system comprises an application or feature that tracks a customer's experience, including through the use of questionnaires or surveys. Surveys are useful for tracking experiences and allowing the system to track preferences and personal information about customers, if the customers elect to share the information to improve service and improve their experiences. Questionnaires or surveys are useful for tracking personal information, if the customer chooses, to allow for special treatment for birthdays, anniversaries, personal dining preferences and the like.

In another embodiment, the system comprises an application or feature that uses artificial intelligence (“AI”), including available AI applications in order for the system to learn and to enhance its own abilities as discussed in this description as well as to learn about customers and diners to improve and enhance dining experience.

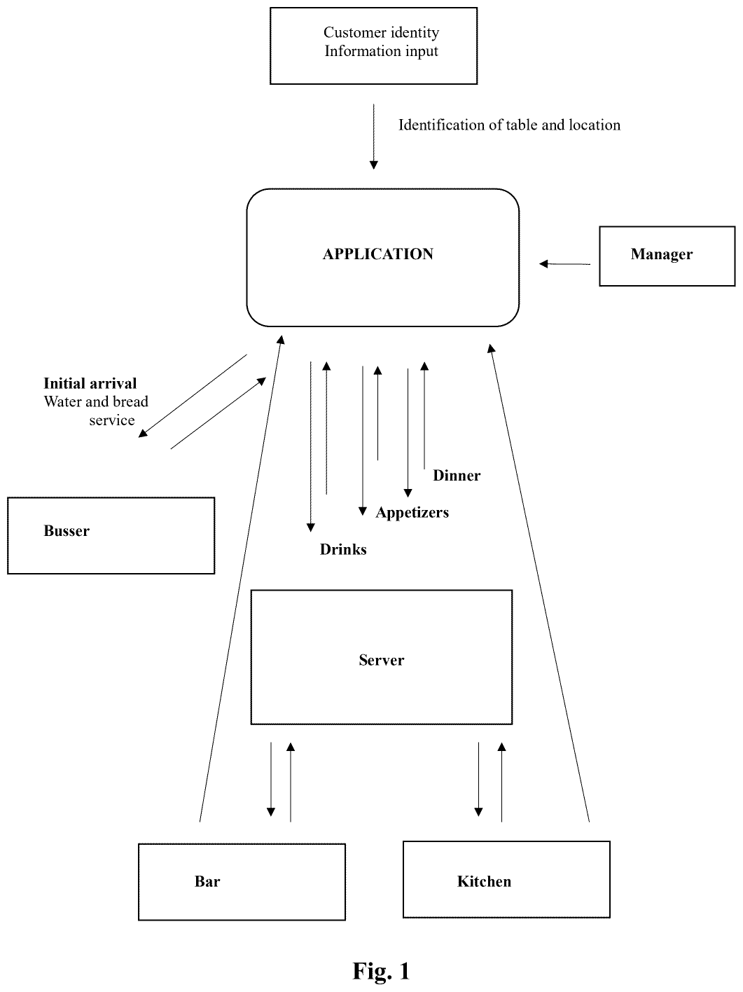

FIG. 1 illustrates at least one embodiment of the invention. In one embodiment, the customer arrives at the restaurant and inputs identification that may identify that particular customer, including the number of customers and other necessary information, including the dining preferences, and or dining location, and the like. That information may be entered into the application in an efficient and simplified manner, using known restaurant terms and quantities. The application may immediately register the information and may act as the host in order to locate and find the appropriate table and or setting and or location for that customer. The customer may then be directed by the application either by itself or in conjunction with another person or assistant to the table. The application may also immediately notify a waiter or busser about the arrival of a customer or customers to a particular table, site, or location. The busser may be required to initiate predetermined introductory service such as the service of water, bread or other introductory items including chips or salsa, small salads, crackers, butter, cheese and/or other items the restaurant might serve. Upon completion of the introductory service the busser may identify the items as complete in the application, and the application may send a signal to the server that the customer is ready for the server's services, including drink orders, appetizer orders, or dinner orders, as well as other considerations including specials, or physical considerations that the customer may seek inquiry upon. The server may enter each of these pieces of information into the application, both generically, and as the case may be specifically, and proceed to fulfill the requirements. As the requirements are met, the server may identify them in the application. Any unfulfilled service, whether with the busser or the server or other personnel, may initiate and alert from the application which alert may be made to the busser or server, or if desired the manager or other person, until the service is satisfied or addressed. The system may continue through the application throughout the course of the dining experience from drinks to special considerations, to appetizers through various courses, including dinner and or the main course, and after dinner services including drinks and desserts. The application is set up in a matter that logging and identifying the requests may be convenient and efficient, and require very little time on the server on the front end, while saving both the server and the customer time on the back. During the process, the server may communicate with the bar, and the kitchen, for drinks and food respectively as well as communicate with other personnel in the restaurant for special considerations, and each of these communications may be tracked by the application, which may identify at a certain period of time any order or service that has gone unfulfilled for a certain amount of time. The manager, or suitable person, is able to assess, monitor, manage, check and review the activity associated with the application. The manager has access to all facets of the application, and can view in real time the status of each activity associated with diner, order, server, busser and the like.

The application may be a computer application, using computer code and/or source code and may require hosting through an application or a third party application or vendor, and may employ a graphical user interface (e.g., a webpage or dialog box), an instruction (e.g., one or more prompts) for a user to provide the location of computer code, which may be, for example, the code for a software application (e.g., a mobile application) or website, or any other computer code. The application may account for and log events that takes place in the network environment, such as an activity of a customer, a user, a transaction, an application, a server, a network or a mobile device.

What is claimed is:

1. A mobile application in which the application acts as a host to communicate with the bussers, servers and managers to coordinate dining for a user, such as a diner, in a dining facility, such as a restaurant.

2. The mobile application of claim 1 in which the application directs the diner to a specific room, table or location for dining within a dining facility.

3. The mobile application of claim 1 in which the application directs the busser to provide introductory items, such as bread and water to the diner.

4. The mobile application of claim 1 in which the application directs a server to the diner.

5. The mobile application of claim 1 in which the application directs a busser to remove some or all items from the diner's table, such as used dishes.

6. The mobile application of claim 1 in which the application tracks tables, diners, bussers and servers to ensure a diner and/or table are being attended.

7. The mobile application of claim 1 in which the diner interacts with the mobile application on site.

8. The mobile application of claim 1 in which the diner interacts with the mobile application remotely.

9. The mobile application of claim 1 in which the application uses a series of communication signals to make alerts.

10. The mobile application of claim 1 in which the application has reminder alerts to communicate with a busser, server or other staff member regarding a pending service item.

11. The mobile application of claim 1 in which the application has a system for tracking a customer's experience, including quick surveys as well as comprehensive surveys.

12. The mobile application of claim 9 in which the communication signals are lights.

13. The mobile application of claim 9 in which the communication signals are buzzers or sounds.

14. The mobile application of claim 9 in which the communication signals are displayed on one or more monitors for visualization by users.

15. The mobile application of claim 1 in which the diner, as the user, is able to enter information to initiate the user's intended use of the dining facility.

16. The mobile application of claim 13 in which the application is an interactive device, such as a kiosk, a smart phone, a laptop, a touch-sensitive monitor.

17. A mobile application for a restaurant host, in which the application directs operation of restaurant functions, including bussers and servers.

18. The mobile application of claim 15 in which the application is used in conjunction with a POS system.

19. A mobile application for a restaurant host, in which the application directs operation of restaurant functions, including waiter services, bartender services, kitchen services.

20. The mobile application of claim 17 in which the application is used in conjunction with a POS system.

21. A system for facilitating a mobile application for restaurant operation, said system comprising: one or more computer applications in which the application transfers communication regarding dining information from a customer to restaurant staff, said restaurant staff comprising managers, hosts, servers, bussers, bartenders, bussers and other service personnel.

22. A system for facilitating a mobile application for restaurant operation, said system comprising an application that communicates requests and completed requests of customers with servers.

23. A system for facilitating a mobile application for restaurant operation, said system comprising an application that communicates requests and completed requests of customers to various servers, including waiters, bussers, bartenders, kitchen staff.

24. A method for facilitating a mobile application for restaurant operation, said method comprising an application in which a customer inputs data at a restaurant, which data is then communicated tor a server, which server then provides, either simultaneously or temporally: (1) instructions, if necessary, to the customer regarding seating or dining location; (2) instructions, if necessary, to a busser regarding requirements for the customer's table; and/or (3) instructions, if necessary, to a server regarding service to the customer.

25. A method for facilitating a mobile application for restaurant operation, said method comprising an application in which a customer inputs data at a restaurant, which data is then communicated tor a server, which server then provides, either simultaneously or temporally: (1) instructions, if necessary, to the customer regarding seating or dining location; (2) instructions, if necessary, to a busser regarding requirements for the customer's table; (3) instructions, if necessary, to a server regarding service to the customer; (4) instructions, if necessary, to a busser regarding removal of items from a customer's table or location; and/or (5) communication from the busser to the application regarding the availability of a table or location within the restaurant.
